(19) United States
(12) Patent Application Publication
(10) Pub. No.: US 2008/0293156 A1
(43) Pub. Date: Nov. 27, 2008

(54) DEVICES AND METHODS FOR DISPENSING REAGENTS INTO SAMPLES

(75) Inventor: Jeffrey D. Smith, Marine on St. Croix, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/751,918

(22) Filed: May 22, 2007

(51) Int. Cl. G01N 1/20; B01L 11/00; B01L 9/00

(52) U.S. Cl. 436/174; 422/104; 422/99

(57) ABSTRACT

Devices and methods of dispensing and mixing reagents with samples in an enclosed container in which the amounts of the reagents dispensed into the sample are predetermined. The devices include dispensing covers attached to a funnel that feeds into a sample chamber. The dispensing covers may contain off-axis dispensing chambers that are sealed and that can be opened and any reagent(s) located therein dispensed into the at selected times. The off-axis dispensing chambers are preferably offset from a main axis of the device, such that the reagents dispensed from the dispensing chambers fall, under the force of gravity, onto the funnel wall and are then directed into the sample chamber.

The present invention relates generally to the dispensing of reagents into samples.

The dispensing of reagents into small volume samples (e.g., samples with a volume of about 2 milliliters or less) can be problematic. In many instances, skilled laboratory personnel are required to accurately dispense and mix reagents with collected samples. As a result, many different analyses must be performed in laboratory settings that are removed from the location at which the sample is collected (e.g., a doctor's office, hospital, etc.).

The need to transfer the samples may add to the potential for error, as samples may be misplaced, inaccurately labeled, etc. during transport. Furthermore, the remote processing of samples typically adds time and additional expense to the procedures.

In addition, even skilled laboratory personnel may occasionally dispense the wrong reagents and/or the wrong amounts of reagents with samples. In such situations, the results of any analyses performed using the reagents and the samples may be erroneous.

### SUMMARY OF THE INVENTION

The present invention provides devices and methods of dispensing and mixing reagents with samples in an enclosed container in which the amounts of the reagents dispensed into the sample are predetermined.

It may be preferred that the devices include dispensing covers attached to a funnel that feeds into a sample chamber. The dispensing covers may preferably include off-axis dispensing chambers that are sealed and that can be opened and any reagent(s) located therein dispensed at selected times. The off-axis dispensing chambers are preferably offset from a main axis of the device, such that the reagents dispensed from the dispensing chambers fall, under the force of gravity, onto the funnel wall and are then directed into the sample chamber.

The different dispensing chambers may contain the same or different reagents. It may be preferred that the dispensing operation be capable of manual actuation, i.e., it may be preferred that a user may use finger pressure to open and dispense reagents contained in the dispensing chambers.

The use of sealed dispensing chambers containing reagents can provide greater efficiency, less sample contamination, less sample loss through transfer, better stability, and longer shelf life.

As used herein, the term “reagent” (and variations thereof) may include any substance that may be useful in performing one or more different tests, assays, etc. on test samples deposited into the devices of the invention. Examples of some potentially suitable reagents may include, but are not limited to, any liquid (e.g., water, saline, alcohol, organic solvents, etc.), neutralizing agents (e.g., a buffer to adjust pH, a material to block or inhibit nuclease, enzyme substrates such as a protein to neutralize an enzyme activity, etc.), digesting agents that depolymerize other materials (e.g., chemical or enzymatic agents to dissolve mucous, proteases to break down proteins, glycosidases to break down complex carbohydrates, lipases, nucleases, etc.), lytic agents to lyse or permeabilize target cells (e.g., lysozyme, lysostaphin and protease K, phospholipases, organic solvents, etc.), buffers, mucolytic agents (such as enzymes, salts, solubilizing agents (e.g., surfactants, detergents, etc.), reducing agents, acids, etc.), labeling agents (e.g., reactant molecules for analyte binding such as antibodies, lectins, enzymes, and receptors and other binding pair technologies, as well as other reactant molecules that recognize metabolic by-products (e.g., pH changes, detectable enzyme production)), etc.

In one aspect, the present invention provides a self-contained device for dispensing reagents into a sample. The device includes a sample chamber having a collection well and an inlet; a funnel with an outlet attached to the inlet of the sample chamber, wherein the funnel has a mouth larger than the outlet and a funnel wall extending between the mouth and the outlet; and a dispensing element located over the mouth of the funnel, the dispensing element including a plurality of off-axis dispensing chambers, wherein each off-axis dispensing chamber of the plurality of off-axis dispensing chambers includes an enclosed volume containing a reagent; wherein the collection well, the inlet of the sample chamber, the outlet of the funnel and the mouth of the funnel are located along a main axis, and wherein the plurality of off-axis dispensing chambers are offset from the main axis; and wherein, when the main axis is aligned with the force vector of gravity and the device is oriented such that the sample chamber is located below the funnel outlet relative to the force vector of gravity, the plurality of off-axis dispensing chambers are offset from the main axis by a distance large enough such that the reagent dispensed from the off-axis dispensing chambers falls under the force of gravity onto the funnel wall before entering the sample chamber.

In another aspect, the present invention provides a self-contained device for dispensing reagents into a sample, the device including a sample chamber having a collection well and an inlet; a funnel with an outlet attached to the inlet of the sample well, wherein the funnel has a mouth larger than the outlet, wherein the mouth has a mouth area and the outlet has an outlet area, and wherein the mouth area to outlet area ratio is 1.5:1 or higher, and further wherein material dispensed into the mouth of the funnel is directed through the outlet into the inlet of the sample well when the sample well is located below the funnel relative to the force vector of gravity; and a dispensing element located over the mouth of the funnel, the dispensing element having a plurality of off-axis dispensing chambers, wherein each off-axis dispensing chamber of the plurality of off-axis dispensing chambers has an enclosed volume containing a reagent; wherein the collection well, the inlet of the sample chamber, the outlet of the funnel and the mouth of the funnel are located along a main axis, and wherein the plurality of off-axis dispensing chambers are not located along the main axis.

In another aspect, the present invention provides a method of dispensing one or more reagents into a sample, the method including depositing a sample into a sample chamber of a device, wherein the sample chamber has a collection well and an inlet, and wherein the device further includes a funnel that has an outlet attached to the inlet of the sample well, wherein the funnel has a mouth larger than the outlet and a funnel wall extending from the mouth to the outlet; attaching a dispensing element over the mouth of the funnel, wherein the dispensing element includes a plurality of off-axis dispensing chambers, and wherein the dispensing element encloses a volume defined by the dispensing element, the funnel, and the sample chamber, wherein the collection well, the inlet of the sample chamber, the outlet of the funnel and the mouth of the funnel are located along a main axis, and wherein the plurality of off-axis dispensing chambers are offset from the main axis; dispensing a reagent from at least one off-axis dispensing chamber of the plurality of off-axis dispensing chambers, wherein, when the main axis is aligned with the force vector of gravity and the device is oriented such that the sample chamber is located below the funnel outlet relative to the force vector of gravity, the reagent dispensed from the off-axis dispensing chambers falls under the force of gravity onto the funnel wall before entering the sample chamber.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the, ” “at least one,” and “one or more” are used interchangeably. Thus, for example, a cap or vial that includes a reagent can include one or more reagents.

The term “and/or” means one or all of the listed elements or a combination of any two or more of the listed elements.

The above summary is not intended to describe each embodiment or every implementation of the present invention. Rather, a more complete understanding of the invention will become apparent and appreciated by reference to the following Detailed Description of Exemplary Embodiments and claims in view of the accompanying figures of the drawing.

### BRIEF DESCRIPTION OF THE VIEWS OF THE DRAWING

The present invention will be further described with reference to the figures of the drawing, wherein:

FIG. 1 is an exploded diagram of one exemplary device according to the present invention.

FIG. 2 is a cross-sectional view of the device of FIG. 1.

FIG. 3 is a cross-sectional view of one alternative access port that may be provided in the devices of the invention.

FIG. 4 is a cross-sectional view of an alternative device located in a standing base.

### DETAILED DESCRIPTION OF ILLUSTRATIVE EMBODIMENTS

In the following detailed description of illustrative embodiments of the invention, reference is made to the accompanying figures of the drawing which form a part hereof, and in which are shown, by way of illustration, specific embodiments in which the invention may be practiced. It is to be understood that other embodiments may be utilized and structural changes may be made without departing from the scope of the present invention.

Operation of the devices of the present invention may preferably rely on gravitational forces and orientation of the devices of the invention relative to those gravitational forces. As used herein, “gravity” (and its force vectors—where a force vector is indicative of the direction of the gravitational force on an object) may be real or apparent. Apparent gravity can be generated by, e.g., spinning the device such that centrifugal forces provide the apparent gravitational forces used to move materials in the devices.

Because the devices of the present invention are preferably designed to rely on gravitational forces (real or apparent), the orientation of the components in devices of the invention may be described as “above” or “below” other components. Any such terms should be understood as indicating position relative to the gravitational forces (i.e., the force vectors) acting on the device with the gravitational force tending to move materials in what is referred to as a downward direction. In other words, a component identified as being located “above” another component is located in a direction that is opposite the force vector of gravity while a component that is identified as being “below” another component is located in a direction that is the same as the force vector of gravity.

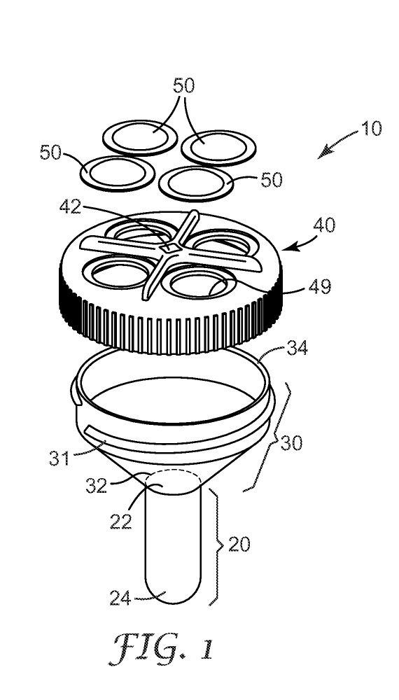

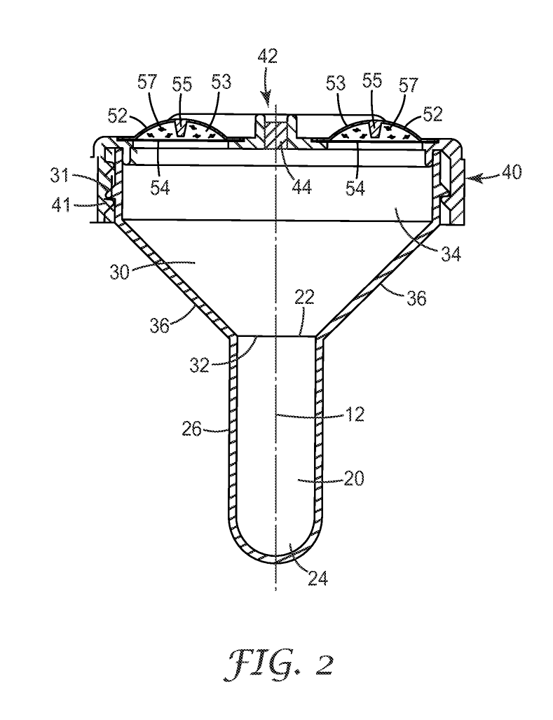

One exemplary device 10 according to the present invention is depicted in the exploded diagram of FIG. 1 as well as the cross-sectional view of FIG. 2. The device 10 includes a housing sample chamber 20, funnel 30, dispensing cover 40, and dispensing chambers 50.

It may be preferred that the material or materials used to construct the sample chamber 20, the funnel 30, and the dispensing cover 40 (or at least those portions of those components that will contact the sample and/or reagents) be non-reactive with the sample and/or reagents. Examples of some potentially suitable polymeric materials that could be used in many different applications may include, but are not limited to, polycarbonate, polypropylene (e.g., isotactic polypropylene), polyethylene, polyester, etc. Other materials such as, e.g., glass, silicon, etc. may also be used for at least portions of some devices.

It may be preferred that the sample chamber 20 and the funnel 30 be integrated together in a unitary molded body as depicted in FIGS. 1& 2. Alternatively, the sample chamber 20 and the funnel 30 may be provided as separate and discrete articles that are attached by any suitable technique or techniques (e.g., welding, threaded connectors, friction fit connection, adhesives, etc.).

The sample chamber 20 includes an inlet 22 and a collection well 24 that is preferably located opposite from the inlet 22. The collection well 24 may preferably have a rounded shape as depicted in FIGS. 1 & 2 to assist with collecting any sample and reagents delivered to the sample chamber 20 in as small of a volume as possible.

The portion of the sample chamber 20 located between the collection well 24 and the inlet 22 may have a uniform cross-sectional area as depicted in FIGS. 1 & 2 in which the wall 26 forms a right circular cylinder. It should be understood, however, that the sample chamber 20 may take many other alternative shapes, e.g., the cross-sectional area of the sample chamber may decrease when moving from the inlet 22 to the collection well 24, the body may be formed as a hexagonal or other non-circular tube, etc. Furthermore, in some instances, the collection well 24 may be located in direct communication with the inlet 22, i.e., the wall 26 may be shortened or even non-existent in some embodiments of sample chambers used in connection with the present invention.

In the embodiment of device 10 depicted in FIGS. 1 & 2, the funnel 30 includes an outlet 32 attached to the inlet 22 of the sample chamber 20. The funnel also includes a mouth 34 that is larger than the outlet 32, with the funnel 30 tapering from the larger mouth 34 to the outlet 32 along wall 36. Although the outlet 32 and mouth 34 are depicted as having circular shapes, the outlet 32 and/or the mouth 34 may alternatively have other shapes, e.g., hexagonal, square, elliptical, etc. Furthermore, the outlet 32 may have a different shape than the mouth 34. In addition, although the funnel 30 is depicted as including a single continuous wall 36 connecting the circular outlet 32 with the circular mouth 34, the funnels of the present invention may include more than one wall to, e.g., connect a square outlet to a square mouth.

Regardless of the exact shape of the funnels used in connection with the present invention, they preferably function to direct reagents dispensed from above the larger mouths of the funnels into the smaller outlets for subsequent delivery to the inlet of the sample chamber. The funnels used in connection with the present invention may, in some instances, be characterized by a ratio of the mouth to the outlet size (measured as areas). For example, it may be preferred that the mouth area to outlet area ratio of funnels used in connection with the present invention be in the range of 1.5:1 or higher, in some instances 2:1 or higher, or even 2.5:1 or higher.

The device of FIGS. 1 & 2 also includes a dispensing cover 40 and dispensing chambers 50 that, in the depicted embodiment, may be provided in the form of modules that are separate and discrete from the dispensing cover 40. The dispensing chambers 50 may be used to provide reagents that can be dispensed into the sample chamber 20 when the dispensing cover 40 is attached to the funnel 30. Although the device 10 of FIG. 1 includes four dispensing chambers 50, it should be understood that the devices of the invention may potentially include as few as one dispensing chamber or any number of multiple dispensing chambers (i.e., two, three, four, or more dispensing chambers).

With the dispensing cover 40 attached over the mouth 34 of the funnel 30, the cover 40, funnel 30 and sample chamber 20 may, in combination, define a device volume in which any samples and reagents dispensed or otherwise delivered into the sample chamber 20 may be contained. The dispensing cover 40 may preferably be attached over the funnel mouth 34 in a manner that forms a fluid-tight connection. If the dispensing cover 40 is attached with a fluid-tight connection, the device 10 as a whole may preferably provide a sealed volume in which samples and any reagents dispensed therein are contained.

The dispensing cover 40 depicted in FIGS. 1 & 2 is attached to the funnel 30 with a threaded connection using complementary threads 41 on the cover 40 and threads 31 on the funnel 30. A gasket or other sealing member may be used in some embodiments if desired.

The dispensing cover 40 may include a port 42 through which access may be obtained to the enclosed volume of the device 10 when the cover 40 is attached. The port 42 may provide a location through which materials may be delivered into or removed from the device 10. The port 42 may be provided in a variety of forms. In the embodiment depicted in FIG. 2, the port 42 is provided in the form of a resealable member 44 located within the port 42. The resealable member 44 (e.g., septum, etc.) may preferably allow the insertion of a fluid transport device (e.g., pipette, needle, etc.) to access the interior of the device 10, but reseal or close after removal of the fluid delivery device.

Although only one port is depicted in FIGS. 1 & 2, devices of the present invention may alternatively include two or more ports. Also, the port 42 is depicted as being located along the main axis 12 of the device 10. Although such placement of the port 42 may be preferred (with the port 42 centered on the axis 12 being perhaps most preferred), it is not necessarily required. In devices including two or more ports, one of the ports may preferably be centered on the axis 12 while the other ports are located elsewhere on cover 40.

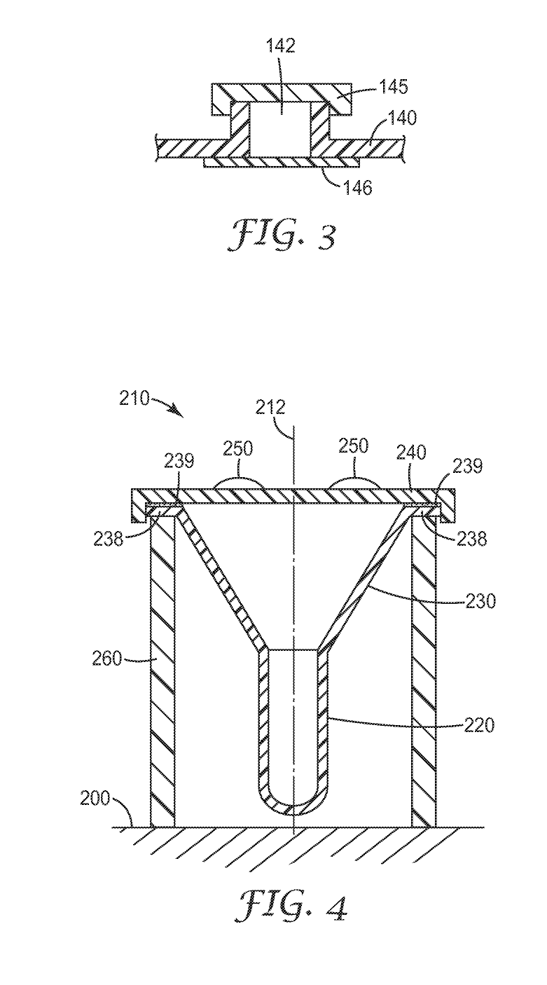

One potential alternative construction for a port that may be used in connection with the present invention is depicted in the cross-sectional view of FIG. 3. Port 142 includes an optional cap 145 that may be provided to help close the port 142 when access to the interior of the device is not required. The cap 145 may be re-usable, i.e., it may be removed from and then replaced on the port 142 to reseal the port 142. In other embodiments, the cap 145 may be constructed such that it cannot be used to reseal the port 142.

In addition to the cap 145, FIG. 3 also depicts a frangible seal 146 that may be provided in connection with port 142. The frangible seal 146 may be provided in the form of, e.g., a polymer film, metallic foil, composite polymer film/metallic foil, etc., that may be punctured, pierced, etc. to gain access to the interior volume of the device. Although the cap 145 and seal 146 are depicted together in FIG. 3, either element may be provided alone in connection with the port 140.

Returning to FIGS. 1 & 2, the dispensing chambers 50 may, as described herein, be provided in the form of discrete modules attached to the dispensing cover 40. Alternatively, the dispensing chambers 50 may be provided as integral components of the cover 40. In any embodiment, it may be preferred that each of the dispensing chambers 50 includes a volume in which one or more reagents are located before being dispensed. It may be preferred that the volumes of the dispensing chambers 50 be sealed such that the shelf-life of any reagents located therein may be increased.

It may be preferred that the dispensing chambers be formed as “blister-packs” in which one side of the chamber is deformed to force any reagent located therein through an opposing side of the dispensing chamber. One example of such a construction is depicted in the cross-sectional view of FIG. 2 where the dispensing chamber 50 includes a first side 52 and an opposing second side 54, with a volume 53 defined between the first and second sides.

It may be preferred that the first side 52 be formed in the shape of a dome such that deformation of the first side 52 in the dispensing operation flattens or even inverts the first side 52. The first side 52 may preferably be formed of materials that are suitable for deformation, e.g., polymers, metallic foils, woven materials, knitted materials, nonwoven materials, etc. and combinations thereof. The selection of specific materials may be based on a variety of factors including compatibility with the reagents and sample materials, manufacturability, etc.

The second side 54 may preferably be manufactured of materials that will rupture or tear when desired, e.g., polymer films, metallic foils, woven materials, knitted materials, nonwoven materials, etc. and combinations thereof. One example may be a polymer film/metallic foil laminate. The selection of specific materials may be based on a variety of factors including compatibility with the reagents and sample materials, manufacturability, etc.

The materials used to construct the dispensing chambers may preferably be amenable to the sealing required to contain any reagents therein. For example, the materials used to construct first and second sides 52 and 54 of the dispensing chambers 50 may be suitable for heat sealing, solvent welding, ultrasonic bonding, adhesive attachment, etc.

Although the dispensing chambers 50 may be provided as discrete modules that can be located within apertures 49 in the cover 40, they may alternatively be provided in an integral construction in which at least one side of the dispensing chamber is formed integrally with the cover 40 while the other side is then attached to the cover 40 using an appropriate attachment technique (or techniques) that provide the desired level of containment for any reagent located in the dispensing chamber.

It may be preferred that one or both sides of the dispensing chambers 50 include features to assist in dispensing of any reagents located therein. One example of such a feature is the post 55 located protruding from the inner surface of the first side 52. The post 55 may preferably act as a force concentrator to assist in opening the second side 54 of the dispensing chamber 50 when the first side 52 is pressed against the second side 54 to dispense any reagents located in the dispensing chamber 50. Other features that may be used to assist in dispensing may include, e.g., lines of weakness formed in the second side 54 where the second side may preferentially separate along the line of weakness. Lines of weakness may be formed by, e.g., thinning the second layer 54 along a selected line, perforating one or more layers provided in the second side 54, etc. Examples of some potentially suitable dispensing chamber constructions may be described in, e.g., U.S. Pat. Nos. 3,326,363; 3,796,813; 4,785,931; 5,035,320; etc.

As discussed herein, the dispensing chambers 50 may preferably be used to dispense one or more reagents 57 into the device at a selected time. The reagents may be in any suitable form, e.g., liquids, powders, granules, tablets, etc. and combinations thereof. It may be preferred that any reagents located in the dispensing chambers release consistently and completely from the dispensing chambers.

Another feature depicted in FIGS. 1 & 2 is the arrangement of the various components relative to, e.g., a main axis 12. It may be preferred that the sample chamber inlet 22, funnel outlet 32 and funnel mouth 34 are aligned (preferably centered) along the main axis 12 as depicted.

It may also be preferred that at least some of dispensing chambers 50 are arranged such that they are not located along the main axis 12. The dispensing chambers 50 that are not located along the main axis 12 may be referred to as “off-axis” dispensing chambers that are offset from the main axis. The offset distance (i.e., the distance by which the off-axis dispensing chambers 50 are offset from the main axis) may preferably be large enough such that reagent dispensed from the off-axis dispensing chambers 50 falls under the force of gravity onto the wall 36 of the funnel 30 before entering the sample chamber 20 (after passing through the funnel outlet 32 and the sample chamber inlet 22).

The offset distance by which the off-axis dispensing chambers 50 are offset from the main axis 12 may preferably be large enough such that when the sample chamber inlet 22 is projected on the dispensing cover 40 in the direction of the main axis 12, the enclosed volume within each of the off-axis dispensing chambers 50 may be located entirely outside of the projected area of the sample chamber inlet 22. In another characterization, the off-axis dispensing chambers 50 may be described as being located above the wall 36 of the funnel 30.

After entering the sample chamber 20, it may be preferred that the dispensed reagents move into the collection well 24 (preferably under that force of gravity) where they contact any materials (e.g., a sample) located in the collection well 24.

As discussed herein, some devices 10 may include dispensing chambers 50 in which each of the dispensing chambers contain different reagents. Alternatively, two or more dispensing chambers 50 may contain the same reagent (or combination of reagents), thus providing a user with the ability to dispense the same reagent at different times.

Some potentially suitable alternative features that may be provided in connection with the devices of the present invention are depicted in FIG. 4 wherein the device 210 includes a sample chamber 220, funnel 230, and dispensing cover 240 with dispensing chambers 250. One optional feature depicted in FIG. 4 is a standing base 260 that may be used to hold the device 210 upright on a surface 200. Typically, the surface 200 will be a table, bench, desktop, counter, etc. oriented perpendicular to the force vector of gravity (i.e., the surface 200 is horizontal). It may be preferred that the standing base 260, when located on a horizontal surface, hold the device 210 such that the main axis 212 of the device 210 is aligned with the force vector of gravity (i.e., the main axis 212 is generally vertical relative to the horizontal surface 200).

The standing base 260 is depicted a separate and discrete article that is not connected or attached to the device 210. In some embodiments, however, the device may be designed with an integrated standing base such that a separate and discrete standing base 260 is not required. Furthermore, the standing base 260 depicted in FIG. 4 is essentially a cylindrical housing in which the device 210 rests (with flange 238 resting on the standing base 260). Many other structures may, of course, be substituted for the exemplary standing base depicted in FIG. 4.

Another alternative feature depicted in FIG. 4 is that the cover 240 is attached to the funnel 230 using an adhesive 239 located between the funnel 230 and the cover 240. The funnel 230 may preferably include a flange 238 as depicted in FIG. 4 to provide a larger surface area for the adhesive 239. The larger surface area provided by the flange 238 (and any corresponding surface on the cover 240) may preferably enhance the adhesive force generated between the flange 238 and cover 240. In addition, the adhesive 239 may be used to provide a fluid-tight seal between the cover 240 and the flange 238 (and, thus, the funnel 230). The larger surface area may be used to enhance the fluid-tight seal formed between the flange 238 and cover 240.

Although a threaded connection is depicted in connection with the device of FIGS. 1 & 2 and adhesive attachment is depicted in connection with the device of FIG. 4, still other alternative bonding techniques may be used to attach the covers to funnels in connection with the present invention. Some potentially suitable alternatives may include, for example, ultrasonic welding, heat sealing, etc.

The adhesives used in connection with the present invention may preferably exhibit pressure sensitive properties. Such adhesives may be more amenable to high volume production of sample processing devices since they typically do not involve the high temperature bonding processes used in melt bonding, nor do they present the handling problems inherent in use of liquid adhesives, solvent bonding, ultrasonic bonding, and the like.

It may be preferred that the pressure sensitive adhesives used in connection with the sample processing devices of the present invention include materials which ensure that the properties of the adhesive are not adversely affected by water. For example, the pressure sensitive adhesive will preferably not lose adhesion, lose cohesive strength, soften, swell, or opacify in response to exposure to water during sample loading and processing. Also, the pressure sensitive adhesive should not contain any components which may be extracted into water during sample processing, thus possibly compromising the device performance.

In view of these considerations, it may be preferred that the pressure sensitive adhesive be composed of hydrophobic materials. As such, it may be preferred that the pressure sensitive adhesive be composed of silicone materials. That is, the pressure sensitive adhesive may be selected from the class of silicone pressure sensitive adhesive materials, based on the combination of silicone polymers and tackifying resins, as described in, for example, “Silicone Pressure Sensitive Adhesives”, Handbook of Pressure Sensitive Adhesive Technology, 3^{rd} Edition, pp. 508-517. Silicone pressure sensitive adhesives are known for their hydrophobicity, their ability to withstand high temperatures, and their ability to bond to a variety of dissimilar surfaces.

Some potentially suitable pressure sensitive adhesive compositions may be described in International Publication WO 00/68336 titled SILICONE ADHESIVES, ARTICLES, AND METHODS (Ko et al.). Other suitable compositions may be based on the family of silicone-polyurea based pressure sensitive adhesives. Such compositions are described in U.S. Pat. No. 5,461,134 (Leir et al.); U.S. Pat. No. 6,007,914 (Joseph et al.); International Publication No. WO 96/35458.

The devices of the present invention may be used to perform a wide variety of test and/or sample preparation processes. With reference to the embodiment depicted in connection with FIGS. 1 & 2, a test sample may be delivered to the sample chamber 20 by any suitable technique, e.g., pipette, swab, etc. In some instances, the test sample may be delivered to the sample chamber 20 before the dispensing cover 40 is attached to the device 10. In other instances, the dispensing cover 40 may be attached to the device 10, with the test sample delivery being performed by, e.g., inserting a pipette, needle, etc. through a port or at another location on the dispensing cover 40.

With the test sample in the sample chamber 20, the reagents contained within the dispensing chambers 50 may be dispensed in any selected order and at any selected time depending on the protocol of the test/sample preparation procedure to be performed on the test sample. Because the dispensing chambers can be opened to release their contents at any selected time, a variety of actions may be performed between dispensing operations. For example, the test sample (and any reagents already dispensed into the test sample) may be heated, cooled, vortexed, agitated, etc. between or after all of the reagents in the dispensing chambers 50 have been released into the sample chamber 20.

At any selected time, the test sample (and any previously dispensed reagents) may be removed from the sample chamber in whole or in part. Removal of materials from the sample chamber may be performed by removing the dispensing cover, by accessing the interior of the device 10 through a port 42 (as discussed herein), or, in some instances, by piercing the cover 40 itself in any suitable location (where the cover 40 is made of a material that can be pierced by a suitable instrument—e.g., pipette tip, needle, etc.).

The devices and methods of the present invention may be used to analyze and/or prepare a test sample for further analysis where the test sample contains a microorganism or other biological material of interest, although certain devices and methods of the present invention have broader applicability with respect to the test sample and the subsequent use of the test sample.

The test sample may be derived from a variety of sources, such as a physiological fluid, e.g., mucous, blood, saliva, ocular lens fluid, synovial fluid, cerebral spinal fluid, pus, sweat, exudate, urine, lactation milk, or the like. Further, the test sample may be derived from a body site, e.g., wound, skin, nares, scalp, nails, etc. Besides physiological fluids, other test samples may include other liquids as well as solid(s) dissolved in a liquid medium. Samples of interest may include process streams, water, soil, plants or other vegetation, air, surfaces (e.g., contaminated surfaces), and the like.

Further information with regard to some potential tests, reagents, and purposes for the devices of the present invention may be found in, e.g., U.S. Provisional Patent Application Ser. No. 60/867,012, titled SYSTEMS AND METHODS FOR SAMPLE PREPARATION USING CAPS AND VIALS.

The complete disclosure of the patents, patent documents, and publications cited in the Background, the Detailed Description of Exemplary Embodiments, and elsewhere herein are incorporated by reference in their entirety as if each were individually incorporated.

Illustrative embodiments of this invention are discussed and reference has been made to possible variations within the scope of this invention. These and other variations and modifications in the invention will be apparent to those skilled in the art without departing from the scope of the invention, and it should be understood that this invention is not limited to the illustrative embodiments set forth herein. Accordingly, the invention is to be limited only by the claims provided below and equivalents thereof.

1. A self-contained device for dispensing reagents into a sample, the device comprising:
a sample chamber comprising a collection well and an inlet;
a funnel comprising an outlet attached to the inlet of the sample chamber, wherein the funnel further comprises a mouth larger than the outlet and a funnel wall extending between the mouth and the outlet; and
a dispensing element located over the mouth of the funnel, the dispensing element comprising a plurality of off-axis dispensing chambers, wherein each off-axis dispensing chamber of the plurality of off-axis dispensing chambers comprises an enclosed volume containing a reagent;
wherein the collection well, the inlet of the sample chamber, the outlet of the funnel and the mouth of the funnel are located along a main axis, and wherein the plurality of off-axis dispensing chambers are offset from the main axis;
and wherein, when the main axis is aligned with the force vector of gravity and the device is oriented such that the sample chamber is located below the funnel outlet relative to the force vector of gravity, the plurality of off-axis dispensing chambers are offset from the main axis by a distance large enough such that the reagent dispensed from the off-axis dispensing chambers falls under the force of gravity onto the funnel wall before entering the sample chamber.

2. A device according to claim 1, wherein the device further comprises a closed port located in the dispensing element.

3. A device according to claim 2, wherein the closed port is located along the main axis.

4. A device according to claim 2, wherein the closed port comprises a frangible seal.

5. A device according to claim 2, wherein the closed port comprises a self-sealing septum.

6. A device according to claim 2, wherein the closed port comprises a cap.

7. A device according to claim 6, wherein the cap is resealable.

8. A device according to claim 1, wherein the device further comprises a standing base, whereby the device stands on a horizontal support with the main axis aligned with the force vector of gravity.

9. A device according to claim 1, wherein the sample chamber and the funnel are formed from a unitary molded body.

10. A device according to claim 1, wherein the sample chamber comprises a tubular body extending between the inlet and the collection well.

11. A device according to claim 1, wherein the device further comprises a fluid-tight connection between the dispensing element and the mouth of the funnel.

12. A device according to claim 11, wherein the fluid-tight connection comprises a threaded connection.

13. A device according to claim 11, wherein the fluid-tight connection comprises adhesive.

14. A self-contained device for dispensing reagents into a sample, the device comprising:
a sample chamber comprising a collection well and an inlet;
a funnel comprising an outlet attached to the inlet of the sample well, wherein the funnel further comprises a mouth larger than the outlet, wherein the mouth comprises a mouth area and the outlet comprises an outlet area, and wherein the mouth area to outlet area ratio is 1.5:1 or higher, and further wherein material dispensed into the mouth of the funnel is directed through the outlet into the inlet of the sample well when the sample well is located below the funnel relative to the force vector of gravity; and
a dispensing element located over the mouth of the funnel, the dispensing element comprising a plurality of off-axis dispensing chambers, wherein each off-axis dispensing chamber of the plurality of off-axis dispensing chambers comprises an enclosed volume containing a reagent;
wherein the collection well, the inlet of the sample chamber, the outlet of the funnel and the mouth of the funnel are located along a main axis, and wherein the plurality of off-axis dispensing chambers are not located along the main axis.

15. A device according to claim 14, wherein, when the main axis is aligned with the force vector of gravity, each off-axis dispensing chamber of the plurality of off-axis dispensing chambers is located directly above a wall of the funnel, whereby reagent dispensed from the off-axis dispensing chamber contacts the wall before it is directed into the sample chamber inlet by the funnel.

16. A device according to claim 14, wherein the device further comprises a standing base, whereby the device stands on a horizontal support with the main axis aligned with the force vector of gravity.

17. A device according to claim 14, wherein the sample chamber comprises a tubular body extending between the inlet and the collection well.

18. A device according to claim 14, wherein the device further comprises a fluid-tight connection between the dispensing element and the mouth of the funnel.

19. A device according to claim 14, wherein the device further comprises a closed port located in the dispensing element.

20. A device according to claim 19, wherein the closed port is located along the main axis.

21. A device according to claim 19, wherein the closed port comprises a frangible seal.

22. A device according to claim 19, wherein the closed port comprises a self-sealing septum.

23. A device according to claim 19, wherein the closed port comprises a cap.

24. A method of dispensing one or more reagents into a sample, the method comprising:
depositing a sample into a sample chamber of a device, wherein the sample chamber comprises a collection well and an inlet, and wherein the device further comprises a funnel that comprises an outlet attached to the inlet of the sample well, wherein the funnel further comprises a mouth larger than the outlet and a funnel wall extending from the mouth to the outlet;
attaching a dispensing element over the mouth of the funnel, wherein the dispensing element comprises a plurality of off-axis dispensing chambers, and wherein the dispensing element encloses a volume defined by the dispensing element, the funnel, and the sample chamber, wherein the collection well, the inlet of the sample chamber, the outlet of the funnel and the mouth of the funnel are located along a main axis, and wherein the plurality of off-axis dispensing chambers are offset from the main axis;
dispensing a reagent from at least one off-axis dispensing chamber of the plurality of off-axis dispensing chambers, wherein, when the main axis is aligned with the force vector of gravity and the device is oriented such that the sample chamber is located below the funnel outlet relative to the force vector of gravity, the reagent dispensed from the off-axis dispensing chambers falls under the force of gravity onto the funnel wall before entering the sample chamber.

25. A method according to claim 24, wherein dispensing a reagent comprises deforming at least a portion of the off-axis dispensing chamber.

26. A method according to claim 24, wherein dispensing a reagent comprises forming an aperture in at least a portion of the off-axis dispensing chamber, wherein the reagent exits the off-axis dispensing chamber through the aperture.

27. A method according to claim 24, wherein attaching a dispensing element comprises forming a fluid-tight connection between the dispensing element and the mouth of the funnel.

28. A method according to claim 24, further comprising accessing the sample in the collection well through a port located in the dispensing element.

29. A method according to claim 28, wherein the port is located along the main axis.

30. A method according to claim 28, wherein the port comprises a frangible seal, and wherein accessing the sample through the port comprises forming an aperture in the frangible seal.

31. A method according to claim 28, wherein the port comprises a self-sealing septum.

32. A method according to claim 28, wherein the port comprises a cap, and wherein accessing the sample through the port comprises removing the cap from the port.
